(19) United States
(12) Patent Application Publication
(10) Pub. No.: US 2006/0271633 A1
(43) Pub. Date: Nov. 30, 2006

(54) Geographically specific broadcasting system providing advisory alerts of sexual predators

(76) Inventor: Robert M. Adler, West Palm Beach, FL (US)

Correspondence Address: MCHALE & SLAVIN, P.A., 2855 PGA BLVD, PALM BEACH GARDENS, FL, 33410, US

(21) Appl. No.: 11/138,669

(22) Filed: May 25, 2005

(51) Int. Cl. G06F 15/16

(52) U.S. Cl. 709/206; 340/7.5; 707/100

(57) ABSTRACT

A method of broadcasting advisory alerts of the movements of sexual offenders and/or predators via communications networks where a central notification computer is provided to broadcast advisory alerts to electronic device addresses stored in a subscriber database in a text, oral, pictorial, and computer retrievable format. The subscriber database contains subscriber data sets which each include the electronic device address and at least one geographic location associated with the electronic device address. When an advisory alert is initiated, the affected geographic area is determined, and a geographic area defined by a perimeter is associated with the advisory alert. An algorithm retrieves addresses of the electronic devices associated with geographical locations within the perimeter; and the advisory alert is transmitted to the electronic device addresses associated with geographic locations within the perimeter.

### RELATED PATENTS

This patent is related to U.S. Pat. Nos. 6,401,095; 6,505,203; 6,581,073 and application Ser. Nos. 10/402423 and 11/207,346, the contents of which are incorporated herein by reference.

### FIELD OF THE INVENTION

This invention relates to communication systems, and in particular to a method of broadcasting advisory alerts of sexual predators in a geographically specific area.

### BACKGROUND OF THE INVENTION

U.S. Pat. No. 6,505,203; 6,401,095 and 6,581,073, issued to the present inventor, including the patents pending, are directed to communication systems which use an algorithm to send geographically targeted e-mail or regarding missing persons, pet loss notification, or the like advisory alerts.

The aforementioned patents instantly canvass specific geographic areas by utilizing an on-line enrollment form to distribute an e-mail, fax, photo email or the like transmission of a lost person or pet. For instance, upon notification of a missing person or lost pet, the system initiates calculations, based upon the last known location of the person or pet, to determine the most appropriate area for the search.

More recently, the public has been made aware of the lack of information concerning dangerous criminals, such as sex offenders and others, especially their whereabouts within the community. When a sex offender becomes a predator, every minute that passes wherein the predator is not confined results in the endangerment of small children.

While the entire public may not be listening to commercial broadcasts at the time of an emergency, a majority of the public is reachable via some sort of electronic communication device. At a given time, most people have access to some sort of communication device such as land based telephones, cellular telephones, pagers, personal computers having Internet connections, PDA, fax machines, etc. The pervasiveness of personal electronic communication devices has a potential, unique in technological history, for widespread emergency communication.

It would therefore be highly advantageous to provide a means to simultaneously broadcast an advisory alert of any of the prior patent targets or the like communication device in order to reach the public with an advisory alert of a sexual predator that is in a geographical area. A picture of a predator sent to a target area where the predator is known to exist may also facilitate quick apprehension of such an individual.

Thus what is needed in the industry is a method of broadcasting geographically specific advisory pictures and or text of sexual predators by utilizing an algorithm which targets recipients only in the affected geographic area.

### SUMMARY OF THE INVENTION

It is an objective of the instant invention to provide a subscriber-based advisory alert broadcast system which transmits advisory alerts to electronic devices such as cellular picture phones, wireless laptops, PDA's such as Blackberry, facsimile machines, e-mail, and the like devices.

It is another objective of the invention is to provide a network between parents in geographical areas wherein if a parent spots a predator the parent can immediately contact all concerned parents in a geographical area of concern.

It is another objective to provide a subscriber-based advisory alert broadcast system which maintains a subscriber database in which the addresses of the personal electronic devices are associated with at least one geographic location.

It is still another objective to provide a subscriber- based advisory alert broadcast system which associates a geographic area with a given advisory alert, and utilizes an algorithm to deliver alerts only to electronic devices associated within the geographic area.

It is still another objective to provide a subscriber- based advisory alert broadcast system which provides central monitoring station which can receive event reports from individual subscribers, thus providing a localized interactive neighborhood crime watch service when a sexual offender or predator is known to be in the area.

It is yet another objective to provide a subscriber-based advisory alert broadcast system which does not require any modification to the end user equipment or software.

It is a further objective of the invention to provide a communications interface for personal electronic devices such as computers, telephones, cellular phones, picture phones, pagers, PDA devices, and fax machines in order to create a universal emergency communications system to alert the public of sexual predators.

Yet another objective of the invention is to provide an advisory alert to visitors in an area of concern. By way of example, should an individual live on the mainland but on vacation in Hawaii, if an advisory alert occurs in Hawaii the vacationer shall be notified while in the specified geographical area.

The applicant proposes a method of broadcasting advisory alerts of sexual predators in sound, pictorial and text format to electronic devices on a subscriber basis via the Internet and telephone networks. The advisory alerts originate from a central notification computer, each electronic device has an address (e.g. an email address or a telephone number) which is associated with at least one geographic location in a subscriber database located on the central notification computer.

When a sexual predator is listed by the government, an advisory alert is initiated, the event triggering the advisory alert is associated with a geographic area having a defined perimeter. For instance, if the individual was seen walking, an area is calculated based on time of sighting and the time a person could walk/run.

In accordance with above objectives, a method of broadcasting advisory alerts via communications networks is as follows: a central notification computer is provided which accesses and monitors government released information on sexual offenders. When a sexual offender is classified as a sexual predator, the information is broadcast through advisory alerts to electronic device addresses stored in a subscriber database. The subscriber database contains subscriber data sets which each include the electronic device address and at least one geographic location associated with the electronic device address. Thus, when an advisory alert is initiated, the affected geographic area is determined, and a geographic area defined by a perimeter is associated with the advisory alert. The area may be calculated by access to subways, trains, cars or if the predator is known to be on foot. An algorithm is activated to retrieve addresses of the electronic devices associated with geographical locations within the perimeter. The advisory alert is then transmitted to the electronic device addresses associated with geographic locations within the perimeter.

While the primary embodiment is directed to those individuals that are classified as sexual predators, the advisory alert can be directed to sexual offenders. The electronic devices that receive the information are preferably those devices that are capable of receiving pictures, whether still or moving, concerning the predator. Another o Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 schematically illustrates the elements and process of the advisory alert broadcast system of the invention;

FIG. 2 is an example an advisory alert transmitted in text format for an emergency situation;

FIG. 3 is an example an advisory alert transmitted in text format for an online neighborhood crime watch system;

FIG. 4 illustrates the structure of the data sets in the subscriber database; and

FIG. 5 is an example of the system architecture.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention.

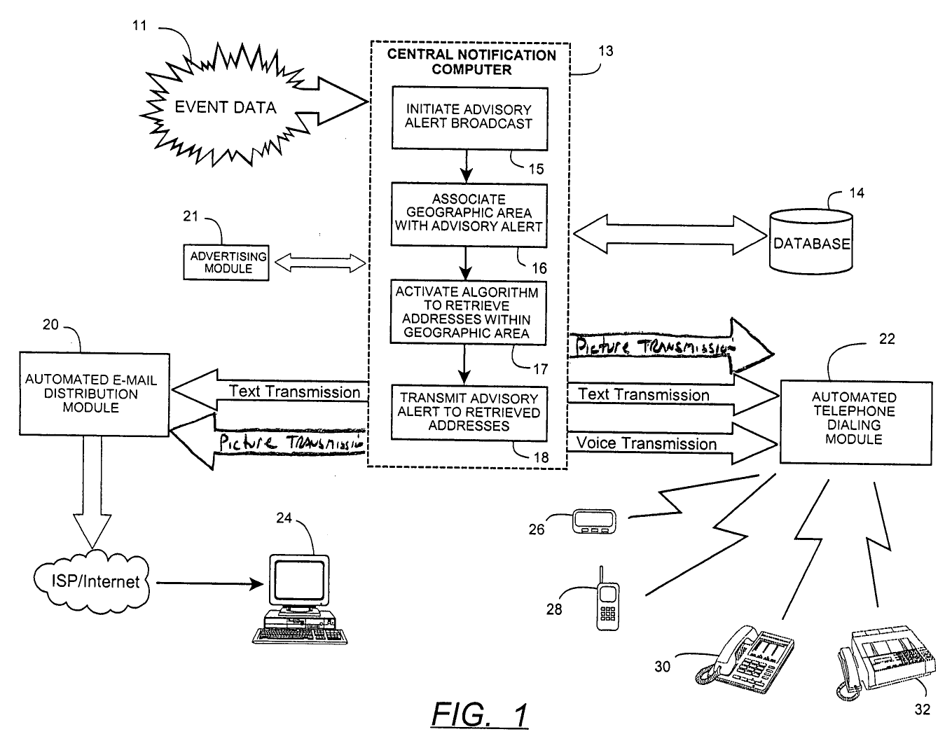

The present invention provides an advisory alert system which transmits text, pictorial and voice messages to electronic devices associated within a given geographic area. The structure of the overall system is schematically illustrated in FIG. 1. A central notification computer 13 is in communication with database 14 of subscribers which are to receive advisory alerts. The subscriber database may be parents of younger children, school teachers, police, and so forth. The central notification computer 13 is shown as a single device for ease of description, however, the central notification computer 13 can be a plurality of computers in a hierarchal arrangement. The personal electronic devices which receive the advisory alerts can be any device which can be connected to a computer network or a telephone network. Suitable devices would include picture phones, personal computers, satellite phones, pagers, PDA devices, fax machines, etc. The database 14 includes a plurality of subscriber data sets which include the address of the device (i.e. an email address or telephone number) and at least one geographic location associated with the device.

An advisory alert is triggered by an event 11 (e.g. a known criminal moving into a neighborhood, a sex offender being reclassified as a sexual predator, etc.) The broadcast of the advisory alert is initiated (step 15) at the central notification computer 13. A geographic area having a defined perimeter is associated with the advisory alert (step 16) which is typically the general location which may be affected by the event 11. An algorithm is then activated (step 17) at the central notification computer 13 to retrieve the electronic device addresses for the subscribers associated with locations within the defined perimeter or when information is provided, a calculated perimeter. The advisory alert is then transmitted in both text, pictorial and voice format to the subscriber addresses. As shown in FIG. 1, a text message is sent to an automated email distribution module 20, which sends notifications to subscriber addresses with are associated with locations within the perimeter. The messages are received by the end users at, for example, personal computer 24 and PDA 34. An automated telephone dialing module 22 transmits the advisory alert in text, pictorial and voice format to devices such as pager 26, cellular telephone 28, land based telephone 30, and fax machine 32.

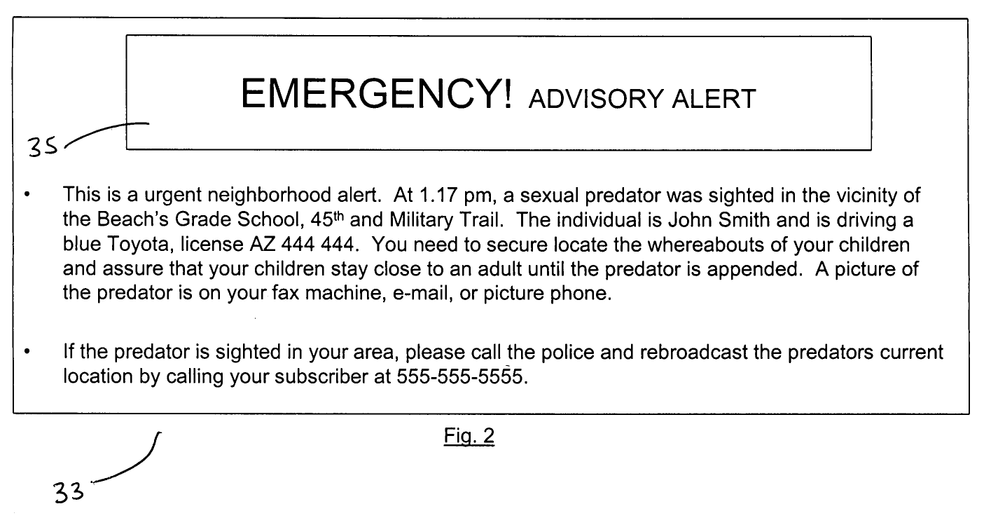

FIG. 2 illustrates an example of an advisory alert 33 for a hypothetical emergency predator situation transmitted in text format. The information provided in the advisory alert 33 is geographically specific to the end user. An advertising field 35 can be juxtaposed with the advisory alert 33 which simultaneously delivers advertising content to the end user. To accomplish this step, an advertising module 21 can be provided which is executable at the notification computer. The advertising module 21 is to select advertisement content from a database of advertisers located within the geographical location associated with the advisory alert and then provide advertisement in conjunction with the advisory alert. The foregoing example was of an advisory alert in text format, however the same content can be sent in the form of a sound recording to a telephone subscribers.

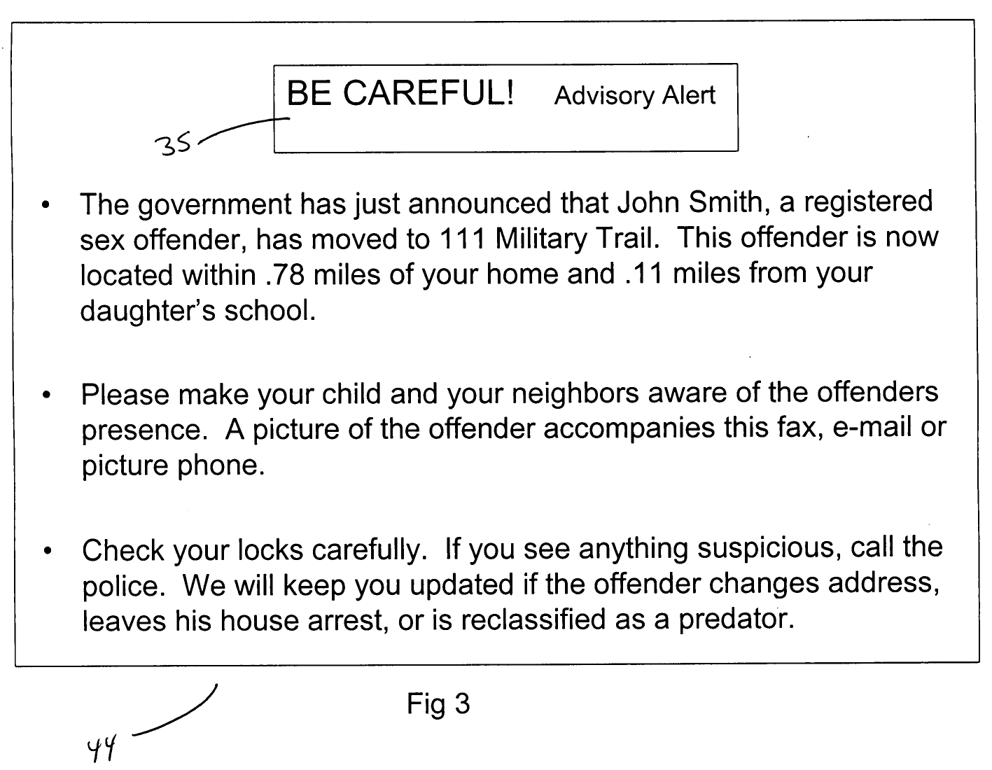

In one aspect of the invention, advisory alerts are disseminated based on information received from conventional sources, such as government-based EAS broadcasts, commercial news organizations and wire services, law enforcement agency data, and or websites, etc. In another aspect of the invention, event-related data can originate from “grass roots” sources so as to provide an on-line neighborhood crime watch system. To implement such a system, an individual subscriber would have a means to provide event reports to a central monitoring station (with human operators) to receive reports which would correlate the information and then disseminate the appropriate advisory alerts through a central notification computer. As described above, the advisory alerts are geographically specific and are sent only to subscribers in the relevant neighborhoods. The reports can include direct observations of criminal acts or suspicious activity, sightings, etc. An example of an advisory alert 44 which may be sent in an “neighborhood crime watch” application of the invention is shown in FIG. 3. In this “neighborhood crime watch” arrangement, the system of the invention provides nearly instantaneous transmission of relevant event data to the affected parties since the event data does not have to filter through the conventional news dissemination entities. The method of the invention can thus provide a neighborhood-based communication network which links the members of the community to one another and rapidly disseminates information vital for the safety of the community.

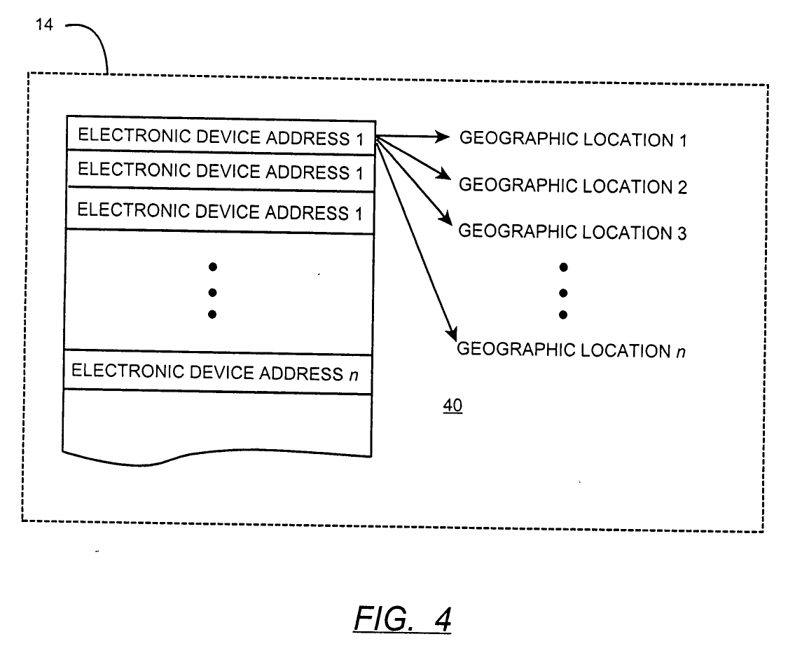

FIG. 4 illustrates an example of the data sets 40 stored in the subscriber database 14. As shown in FIG. 4, each electronic device address 41₁₋ₙ can be associated with a plurality of geographical locations 43₁₋ₙ in the subscriber database. The end user device need not be physically located in the geographical locations 43₁₋ₙ. A subscriber may wish to monitor events taking place in any number of geographic areas at once. For example, a subscriber address can be simultaneously associated with (1) the subscriber's home neighborhood, (2) the neighborhood of the subscriber's workplace, (3) the school attended by the subscriber's children, and (4) the neighborhood of a relative. In addition, it may be desired to provide temporary geographic associations an individual subscriber. In such a situation, a subscriber might be attending a large scale event (such as a concert, festival, or sports event) and would like to remain informed of any sexual predator may be in the immediate area for the duration of the event. In this scenario, the address of the subscriber would be associated with the event location only for the duration of the event.

Advisory alerts transmitted in accordance with the method of the invention will necessarily range from high level alert situations, such as sexual predator spotting, to relatively low level alert situations, such as sexual offender release from prison, and so forth. Other advisory alerts may be transmitted on a repeating basis, for example, the location or address of known sex offenders could be daily, weekly, monthly or other repetitions. The advisory alerts can be graded, for example, on a numerical scale, to indicate the relative degree of danger to the recipient. In an alternative arrangement of the invention, a means is provided for a subscriber to select the lowest threshold level of advisory alert they wish to receive at a selected address. In this way, a subscriber can choose to receive higher alert advisories so that the subscriber is not inundated with low level alerts.

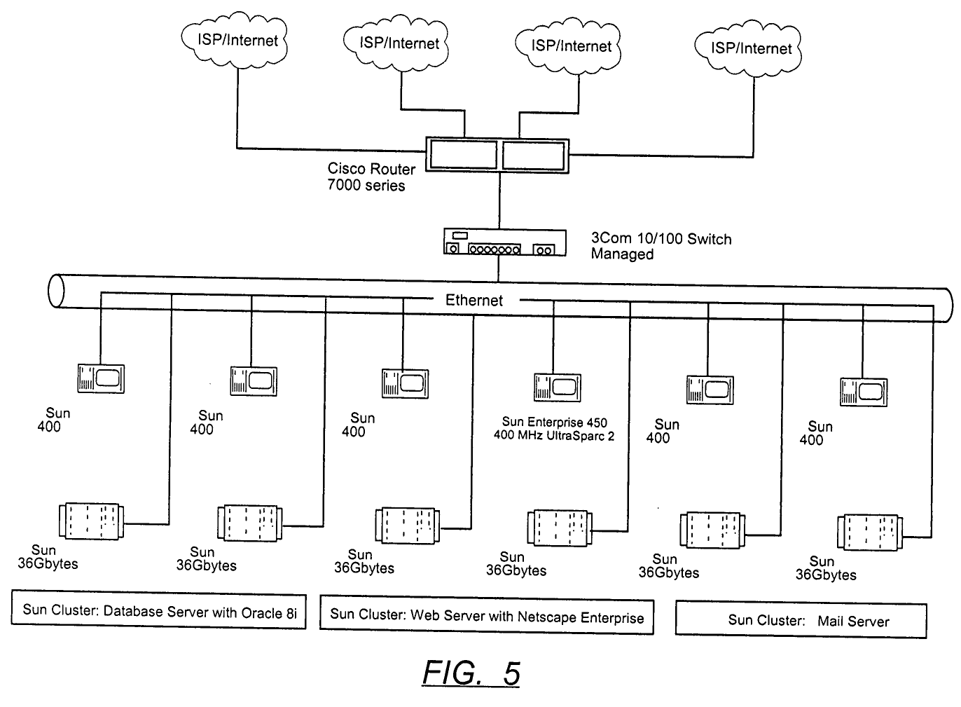

With reference to FIG. 5, a diagram exemplifying the system architecture is shown. The notification system will be divided into four main parts:

1) processing/database system;

2) messaging system;

3) web server; and

4) network/telecom infrastructure. All these parts are off-the-shelf items having the requisite functions. The particular manufacturer and Model is of no import but merely serves as an example.

The database server may rely on two SUN ENTERPRISE 450 servers or equivalents configured to operate as a cluster. ORACLE SERVER EE 8i, coupled with ORACLE PARALLEL SERVER or equivalents will optimize the SUN cluster architecture to provide an optimum database system. Data processing may be handled by ORACLE APPLICATION SERVER ENTERPRISE and ORACLE INTERMEDIA or equivalents.

The messaging system may be based upon a cluster architecture also and may utilize at least two SUN ENTERPRISE 2 Model 1400 servers to support SUN's SENDMAIL messaging server.

Using the same physical architecture as the messaging system, the web server may implement NETSCAPE ENTERPRISE SERVER.

The network/telecom may utilize a device having the capabilities of a CISCO 7500 Series router, particularly preferred is a CISCO 7576. Desirable characteristics are LAN/WAN services support, redundancy, reliability and performance. Scalability is accomplished due to a bandwidth extensible to 4 Gbps. Switching is accomplished via a 3COM SUPERSTACK II Switch 3300 or equivalent.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A method of broadcasting advisory alerts of sexual predators via communications networks, comprising:
providing a central notification computer in communication with at least one communications network, said communications network including portable telephones capable of creating, sending and receiving pictorial messages;
providing a means to transmit an advisory alert to a plurality of electronic device addresses from the central notification computer;
maintaining a subscriber database of electronic device addresses to receive the advisory alerts, wherein the subscriber database includes a plurality of subscriber data sets, the data sets including the electronic device address and at least one geographic location associated with the electronic device address;
maintaining the subscriber database in a computer retrievable format for access by the central notification computer;
providing a means to initiate an advisory alert broadcast from the central notification computer upon an event, said event consisting of the presence of a criminal in a geographic area;
associating a geographic area with the advisory alert, wherein said geographic area is defined by a perimeter;
activating an algorithm to retrieve the electronic device addresses associated with geographical locations within said perimeter; and
transmitting the advisory alert to the electronic device address associated with geographic locations within the perimeter.

2. The method of claim 1, wherein the communications network is a computer network, and the electronic device addresses are picture telephones.

3. The method of claim 2, wherein the advisory alert is in text format; and the means to transmit an advisory alert to a plurality of electronic device addresses is an automated distribution module executable at the notification computer.

4. The method of claim 1, wherein the communications network is a telephone network, and the electronic device addresses are telephone numbers.

5. The method of claim 1, wherein the advisory alert is a sound recording; and the means to transmit an advisory alert to a plurality of electronic device addresses is an automated telephone dialing module executable at the notification computer.

6. The method of claim 1, wherein the advisory alert is in text format; and the means to transmit an advisory alert to a plurality of electronic device addresses is an automated text messaging module executable at the notification computer.

7. The method of claim 6, wherein the advisory alerts in text format are received by PDA's addressable via the electronic device address.

8. The method of claim 1, further including the step of providing an advertising module executable at the notification computer; wherein advertising module configured to select advertisement content from a database of advertisers located within the geographical location associated with the advisory alert, and further configured to provide the advertisement in conjunction with the advisory alert.

9. The method of claim 1 wherein an individual may contact said central notification computer and generate an advisory alert, whereby individuals in the geographical area of the individual receive the advisory alert.

10. The method of claim 1 wherein said computer is associated with a website which is comprised of a plurality of computers.

11. The method of claim 1 wherein said computer polls government web-sites regarding the location and description of sexual offenders and sexual predators.

12. The method of claim 1 wherein said computer can be contacted by government personnel to notify concerned individuals in a specific geographical area of a sexual predator.
